(19) United States
(12) Patent Application Publication
(10) Pub. No.: US 2003/0221315 A1
(43) Pub. Date: Dec. 4, 2003

(54) Mehtod for repairing damaged rotor blades of the turbine part of a gas turbine

(76) Inventors: Robert Baumann, Klingnau (CH); Bettina Bordenet, Brugg (CH)

Correspondence Address: ADAM J. CERMAK, P.O. BOX 7518, ALEXANDRIA, VA, 22307-7518, US

(21) Appl. No.: 10/453,539

(22) Filed: Jun. 4, 2003

(30) Foreign Application Priority Data
Jun. 4, 2002 (CH) 2002 0968/02

(51) Int. Cl. B23P 6/00

(52) U.S. Cl. 29/889.1

(57) ABSTRACT

In a method for repairing damaged rotor blades (17) of the turbine part (11) of a gas turbine (10), at least the surface of the rotor blades (17) which are seated in the turbine part (11) and surrounded by a hot-gas casing is treated from the outside through a suitable opening (23).

A method of this type is particularly simple to carry out and involves minimum shutdown times if those rotor blades (17) which, at the inlet of the turbine part (11), are arranged in a first row behind a first row of guide vanes (17) are treated, and if the spaces (23) between the guide vanes (16) belonging to the first row are used as openings for treating the rotor blades (17).

### FIELD OF THE INVENTION

The present invention deals with the field of gas turbine technology. It relates to a method for repairing damaged rotor blades of the turbine part of a gas turbine in accordance with the preamble of claim 1.

A method of this type is known, for example, from U.S. Pat. No. 5,644,394.

### DISCUSSION OF BACKGROUND

The blades and vanes of gas turbines are exposed to different loads in operation. This is particularly true of the rows of blades and vanes in the turbine part of the gas turbine where the hot combustion gases coming out of the combustion chamber are expanded in such a manner as to perform work. It will automatically be understood that, of the rows of blades and vanes of the turbine part, in particular the first rows are subject to high levels of load, since this is where the gas temperatures and velocities are highest.

Since the operating temperatures of gas turbines are being raised ever higher in order to increase efficiency, it is necessary for ever higher-quality materials to be used for the blades and vanes. At the same time, the blades and vanes are coated with protective layers in various ways in order to protect the blade or vane material from attack by the aggressive hot gases and to extend the service life.

However, during operation, these thermal barrier coatings may become partially detached or may flake off. Since it is extremely expensive to replace damaged blades or vanes of this type, and such an operation would also lead to long shutdown times for the gas turbine, it is desirable for the blades or vanes to be repaired in the installed state by the damaged regions of the coating being replaced and, if necessary, any other damage to the blades or vanes being eliminated in situ.

It has already been proposed in U.S. Pat. No. 5,644,394, which was cited above, to introduce a specially adapted treatment tool with a rotating grinding head into the interior of the machine through small inspection openings in the casing of a gas turbine, in the manner of a catheter, in order to treat damaged front edges of blades or vanes fitted in the turbine, with optical control by means of a camera device carried along with the tool. This requires differently shaped tool inserts to be used for differently arranged blades or vanes.

### SUMMARY OF THE INVENTION

Accordingly, one object of the invention is to provide a method which, in a particularly simple way, enables the rotor blades in the turbine part of a gas turbine which are subject to particularly high levels of load to be treated for repair purposes without the turbine part having to be dismantled.

This object is achieved by the combination of features described in claim 1. The core idea of the invention consists in treating the rotor blades of the first row through the spaces between the guide vanes arranged at the inlet of the turbine part. Since these spaces are distributed over the circumference and have similar dimensions to the rotor blades belonging to the first row, it is possible for tools which are suitable for repair purposes to reach all the rotor blades belonging to the first row relatively easily and under substantially identical conditions.

A preferred configuration of the method according to the invention is distinguished by the fact that treatment devices which can be introduced from the outside through the spaces between the guide vanes belonging to the first row until they reach the rotor blades are used to treat the rotor blades, and that the treatment devices are inherently moveable, in particular flexible, and/or singularly or multiply jointed.

For the surface treatment of the rotor blades, it is particularly advantageous if the treatment devices comprise a grinding device for grinding and/or polishing the surface of the rotor blades, a brush for applying a film of liquid to the surface of the rotor blades, a device for drying a film of liquid located on the surface of the rotor blades, in particular in the form of a hot-air blower.

If the rotor blades are provided on their surface with a protective coating, defective regions of the coating which have formed during operation of the gas turbine are preferably removed by the treatment and replaced by a replacement coating.

In particular, the repair method is distinguished by the fact that, in a first step, the defective coating is removed by means of a grinding process, that, in a second process, a film is applied in the region of the coating which has been removed, forming a protective replacement coating during a subsequent heat treatment, and that, in a third step, the rotor blades which have been provided with the film are subjected to a heat treatment.

The film is preferably applied to the surface of the rotor blades in liquid form and is subjected to a drying process before the subsequent heat treatment.

The bonding of the replacement layer can be improved by the surface of the rotor blades being roughened, in particular by etching, before the film is applied.

A further improvement results if the surface of the rotor blades is polished immediately after the grinding operation and if the film is applied a plurality of times, and is in each case subjected to a drying process between two application operations.

In principle, it is conceivable for the heat treatment of the applied film to be carried out separately. However, the process becomes particularly simple if the heat treatment used is the heating of the gas turbine during the recommissioning which follows the repair operation.

### BRIEF DESCRIPTION OF THE DRAWINGS

A more complete appreciation of the invention and many of the dependent advantages thereof will be readily obtained as the same becomes better understood by reference to the following detailed description when considered in connection with the accompanying drawings wherein:

FIG. 1 shows a longitudinal section through the inlet region of the turbine part of a gas turbine;

FIG. 2 shows a view of the inlet region of the turbine part shown in FIG. 1 in the axial direction;

FIG. 3 shows a view in the radial direction of the first rows of the guide vanes and rotor blades of the turbine part shown in FIG. 1, diagrammatically depicting the use of various types of grinding devices within the context of the invention;

FIG. 4 shows an illustration similar to that presented in FIG. 3, illustrating the use of a brush for applying a liquid film to the rotor blades belonging to the first row;

FIG. 5 shows an illustration similar to that presented in FIG. 3 illustrating the use of a hot-air blower for drying a liquid film which has been applied to the rotor blades belonging to the first row; and

FIG. 6 shows a block diagram illustrating the various steps involved in a repair method in accordance with a preferred exemplary embodiment of the invention.

### DESCRIPTION OF THE PREFERRED EMBODIMENTS

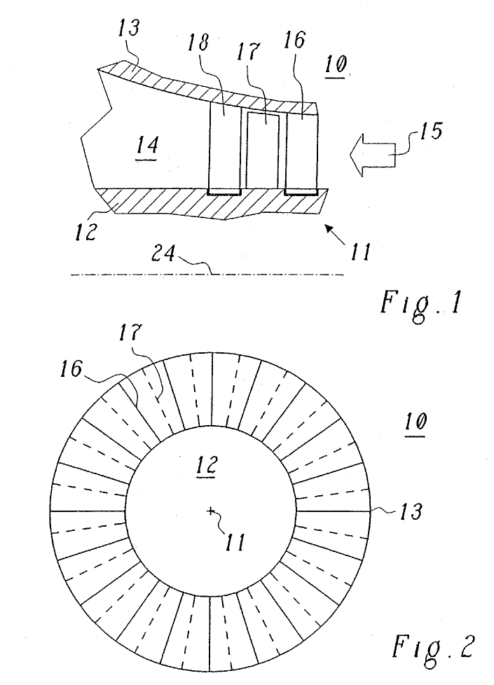

Referring now to the drawings, wherein like reference numerals designate identical or corresponding parts throughout the several views, FIG. 1 illustrates a longitudinal section through the inlet region of the turbine part 11 of a gas turbine 10. A plurality of rows of rotor blades, of which only the first row of rotor blades 17 is shown in the drawing, for the sake of simplicity, are arranged in succession on a rotor 12 which is mounted in such a manner that it can rotate about the axis 24. Rows of guide vanes 16, 18 which are secured to a hot-gas casing 13 which concentrically surrounds the rotor 12 are arranged between the rows of rotor blades. The space between the rotor shaft and the hot-gas casing 13 forms a hot-gas passage 14, through which hot gas 15 flows from right to left, being expanded in such a manner as to perform work. The hot gas 15 comes out of a combustion chamber (not shown in FIG. 1), the outlet of which is adjoined by the turbine part 11. A configuration of this type is illustrated, for example, in U.S. Pat. No. 5,575,617. The first row of guide vanes 16 is positioned in front of the first row of rotor blades 17, toward the combustion chamber.

The rotor blades 17, as the first row of rotor blades, are exposed to a particularly high load from the hot gas 15 flowing into the hot-gas passage 14. Therefore, it is frequently the case that defects occur at these blades first, manifesting themselves by flaking of the thermal barrier coating which has been applied to the surface of the rotor blades. If these defects in the protective layer are not eliminated immediately, the base material of the blades is attacked by oxidation and/or corrosion, which can then lead to greater damage extending beyond the surface. It is therefore important for damage to the protective layer of this type to be eliminated as quickly as possible, with the minimum possible outlay and with a short gas turbine shutdown time.

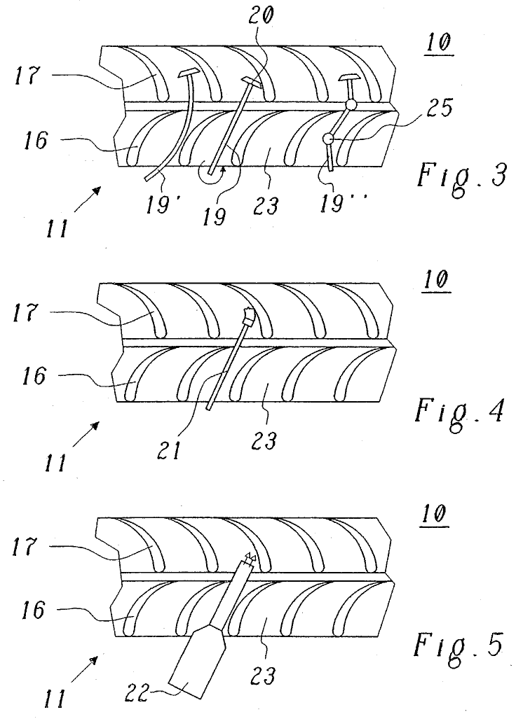

According to the invention, the damaged surfaces of the rotor blades 17 belonging to the first row are now repaired with the blades in the installed position by suitable treatment devices being introduced into the hot-gas passage 14 from the inlet of the turbine part 14 through the spaces (23 in FIG. 3) between the guide vanes 16 and being used to treat the surface of the rotor blades 17. Although the guide vanes 16 overlap in the axial direction (FIG. 2; for this reason, the rotor blades 17 are only shown in dashed lines in the drawings), as shown in FIGS. 3-5, if the guide vanes 16 and rotor blades 17 are placed in a suitable angular position with respect to one another, it is nevertheless easy for a treatment device to reach the pressure surfaces of the rotor blades 17 which are particularly exposed to the hot gas through the spaces 23 (running obliquely) between the guide vanes 16, if the treatment device is designed or guided in a suitable way (FIGS. 3-5).

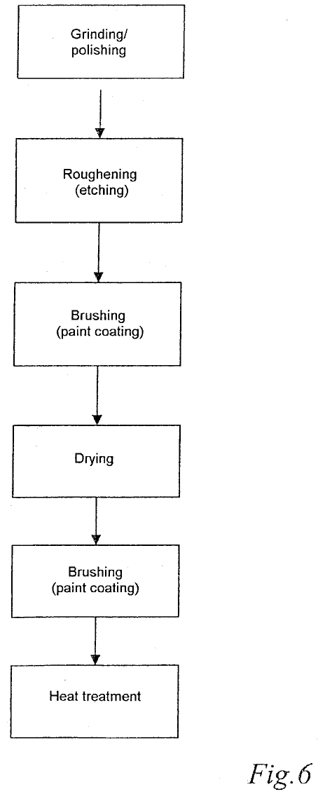

The diagrammatic sequence of the repair method, including its main steps, is represented in FIG. 6: first of all, in a first step, the damaged regions of the coating are removed from the rotor blade. This is preferably implemented by means of a (mechanical) grinding process, which may be followed by a polishing process, in order to smooth the surface. For this purpose, in accordance with FIG. 3, a rotating grinding device 19 with a grinding head 20 can be guided through the space 23 to the rotor blade 17. It is possible to use a rigid grinding device 19, a flexible, inherently moveable grinding device 19′ or a grinding device 19″ provided with a plurality of joints 25, depending on the spatial conditions and the extent of the damaged area. However, other abrasive processes, such as sand-blasting or the like, are also conceivable.

After the polishing operation, the treated surface is prepared to receive a replacement coating by being roughened. The roughening is preferably carried out chemically by etching the surface. When the blade has been prepared for good bonding of the replacement coating in this way, in accordance with FIG. 4 a brush 21 is used to apply a film of liquid to the blade, and this liquid, after a heat treatment, forms the replacement coating. A liquid or suspension of this type is commercially available, for example, under the name “SermaLoy J”, and during a subsequent heat treatment, by means of diffusion, forms a coating with an aluminum-containing alloy (aluminide diffusion coating).

The film of liquid, after it has been applied, is dried as shown in FIG. 5, for example by means of a hot-air blower 22 which has been introduced into the space 23. Liquid can then be brushed on again.

Once the film which has been applied to the blade has the required thickness and consistency, in order to form the replacement coating it can be subjected to a subsequent heat treatment, during which diffusion into the blade takes place. In principle, it is conceivable for this subsequent heat treatment to follow the application of the film as a separate process step. However, it is particularly simple if the heating of the gas turbine during the recommissioning which follows the repair is used for the heat treatment.

Obviously, numerous modifications and variations of the present invention are possible in light of the above teachings. It is therefore to be understood that within the scope of the appended claims, the invention may be practiced otherwise than as specifically described herein.

LIST OF DESIGNATIONS

| | |
|---|---|
| 10 | Gas turbine |
| 11 | Turbine part |
| 12 | Rotor |
| 13 | Hot-gas casing |
| 14 | Hot-gas passage |
| 15 | Hot gas (from the combustion chamber) |
| 16 | Guide vane (1^{st} row) |
| 17 | Rotor blade (1^{st} row) |
| 18 | Guide vane (2^{nd} row) |
| 19,19′,19′′ | Grinding device |
| 20 | Grinding head |
| 21 | Brush |
| 22 | Hot-air blower |
| 23 | Space |
| 24 | Axis |
| 25 | Joint |

1. A method for repairing damaged rotor blades (17) of the turbine part (11) of a gas turbine (10), in which method at least the surface of the rotor blades (17) which are seated in the turbine part (11) and surrounded by a hot-gas casing (13) are treated from the outside through a suitable opening (23), characterized in that those rotor blades (17) which, at the inlet of the turbine part (11), are arranged in a first row behind a first row of guide vanes (16) are treated, and in that the spaces (23) between the guide vanes (16) belonging to the first row are used as openings for treating the rotor blades (17).

2. The method as claimed in claim 1, characterized in that treatment devices (19, 20, 21, 22) which can be introduced from the outside through the spaces (23) between the guide vanes (16) belonging to the first row until they reach the rotor blades (17) are used to treat the rotor blades (17).

3. The method as claimed in claim 2, characterized in that the treatment devices (19, 20, 21, 22) are inherently moveable, in particular flexible, and/or singularly or multiply jointed.

4. The method as claimed in one of claims 2 or 3, characterized in that the treatment devices comprise a grinding device (19) for grinding and/or polishing the surface of the rotor blades (17).

5. The method as claimed in one of claims 2 to 4, characterized in that the treatment devices comprise a brush (21) for applying a film of liquid to the surface of the rotor blades (17).

6. The method as claimed in one of claims 2 to 5, characterized in that the treatment devices comprise a device for drying a film of liquid which is located on the surface of the rotor blades (17), in particular in the form of a hot-air blower (22).

7. The method as claimed in one of claims 1 to 6, characterized in that the rotor blades (17) are provided on their surface with a protective coating, and in that defective regions of the coating which have formed during operation of the gas turbine (10) are removed by the treatment and replaced by a replacement coating.

8. The method as claimed in claim 7, characterized in that, in a first step, the defective coating is removed by means of a grinding process, in that, in a second process, a film is applied in the region of the coating which has been removed, forming a protective replacement coating during a subsequent heat treatment, and in that, in a third step, the rotor blades which have been provided with the film are subjected to a heat treatment.

9. The method as claimed in claim 8, characterized in that the film is applied to the surface of the rotor blades (17) in liquid form and is subjected to a drying process before the subsequent heat treatment.

10. The method as claimed in one of claims 8 and 9, characterized in that the surface of the rotor blades (17) is roughened, in particular by etching, before the film is applied.

11. The method as claimed in one of claims 8 to 10, characterized in that the surface of the rotor blades (17) is polished immediately after the grinding step.

12. The method as claimed in claim 9, characterized in that the film is applied a plurality of times, and is in each case subjected to a drying process between two application operations.

13. The method as claimed in claim 8, characterized in that the heat treatment used is the heating of the gas turbine (10) during the recommissioning which follows the repair operation.
